(19) United States
(12) Patent Application Publication
(10) Pub. No.: US 2025/0175768 A1
(43) Pub. Date: May 29, 2025

(54) COMMUNICATION NETWORK NODE, METHOD CARRIED OUT IN A COMMUNICATION NETWORK NODE, USER EQUIPMENT, METHOD CARRIED OUT IN USER EQUIPMENT, COMMUNICATION SYSTEM, METHOD CARRIED OUT IN A COMMUNICATION SYSTEM

(71) Applicant: Sony Group Corporation, Tokyo (JP)

(72) Inventor: Hideji WAKABAYASHI, Basingstoke (GB)

(73) Assignee: Sony Group Corporation, Tokyo (JP)

(21) Appl. No.: 18/839,736

(22) PCT Filed: Feb. 22, 2023
(86) PCT No.: PCT/EP2023/054357

§ 371 Date: Aug. 20, 2024

(30) Foreign Application Priority Data
Mar. 1, 2022 (EP) 22159511.9

(51) Int. Cl. H04W 4/24; H04L 67/12; H04W 4/029

(52) U.S. Cl. CPC H04W 4/24; H04L 67/12; H04W 4/029

(57) ABSTRACT

The present disclosure pertain to a communication network node comprising circuitry configured to: determine environmental costs of a user's journey based on journey data of the user and based on at least one route option for the journey.

### TECHNICAL FIELD

The present disclosure generally pertains to a communication network node for providing a distributed ledger (e.g., a blockchain), a method carried out in a communication network node, user equipment, a method carried out in user equipment, a communication system, and a method carried out in a communication system.

### TECHNICAL BACKGROUND

Generally, it is known to distribute a ledger over multiple nodes such as entities, e.g. electronic devices, servers or the like, which record digital transactions. Distributed ledgers can be based on the known blockchain technology, on which, for example, the known cryptocurrency bitcoin is based, but also the well-known Ethereum project, etc. Generally, a distributed ledger may also be implemented on other technologies than the blockchain technology and examples of distributed ledger projects which are not based on blockchain are BigchainDB and IOTA or the like. For instance, IOTA is a crypto currency which uses linked lists.

Moreover, mobility as a service (MaaS) is known, where a user or passenger uses mobility as a service without owning, for example, a car or the like. Mobility as a service may combine public (e.g. train, bus, etc.) and private (e.g. car sharing, bicycle sharing, etc.) transportation services from associated operators or providers.

Known MaaS solutions typically involve a central and unified gateway through which a trip or journey is planned and booked, wherein a user may pay with a single account.

Although there exist techniques for providing a distributed ledger and mobility as a service, it is generally desirable to provide a communication network node, a method carried out in a communication network node, user equipment, a method carried out in user equipment, a communication system, and a method carried out in a communication system.

### SUMMARY

According to a first aspect, the disclosure provides a communication network node comprising circuitry configured to:
determine environmental costs of a user's journey based on journey data of the user and based on at least one route option for the journey.

According to a second aspect, the disclosure provides a method carried out in a communication network node comprising:
determining environmental costs of a user's journey based on journey data of the user and based on at least one route option for the journey.

According to a third aspect, the disclosure provides user equipment configured to communicate with a communication network node, the user equipment comprising circuitry configured to:
obtain environmental costs of a user's journey which are determined based on journey data of the user and based on at least one route option for the journey.

According to a fourth aspect, the disclosure provides a method carried out in user equipment configured to communicate with a communication network node, the method comprising:
obtaining environmental costs of a user's journey which are determined based on journey data of the user and based on at least one route option for the journey.

According to a fifth aspect, the disclosure provides a communication system comprising communication network nodes and circuitry configured to:
determine environmental costs of a user's journey based on journey data of the user and based on at least one route option for the journey.

According to a sixth aspect, the disclosure provides a method carried out in a communication system comprising communication network nodes, the method comprising:
determining environmental costs of a user's journey based on journey data of the user and based on at least one route option for the journey.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a system overview of a system according to the present disclosure;

FIG. 2 depicts a method according to the present disclosure in which a route/transport can be selected based on environmental costs;

FIG. 3 shows an embodiment of a method according to the present disclosure for recording environmental costs with a blockchain common database;

FIG. 4 depicts a method for providing an environmental incentive to the user;

FIG. 5 depicts a method 40 for determining individual environmental costs;

FIG. 6 depicts a flowchart of how the environmental cost coefficient is determined according to the present disclosure;

FIG. 7 depicts a diagram showing CO2 emission versus a number of passengers when using a car;

FIG. 8 depicts a diagram showing CO2 emission versus a number of passengers when using railway;

FIG. 9 depicts an overlay diagram including the graphs of FIGS. 7 and 8, such that they can be compared;

FIG. 10 depicts a method according to the present disclosure for determining environmental costs taking marginal costs into account;

FIG. 11 depicts a flowchart of a method according to the present disclosure for calculating environmental costs;

FIG. 12 depicts a flowchart of a method according to the present disclosure for offering a conditional booking;

FIG. 13 depicts a method according to the present disclosure in which an alternative transport is offered;

FIG. 14 illustrates a general structure of a blockchain;

FIG. 15 illustrates input and output of a hash function;

FIG. 16 exemplarily illustrates a process of PBFT;

FIG. 17 depicts an embodiment of a general purpose computer;

FIG. 18 depicts an embodiment of a user equipment and of an eNodeB.

### DETAILED DESCRIPTION OF EMBODIMENTS

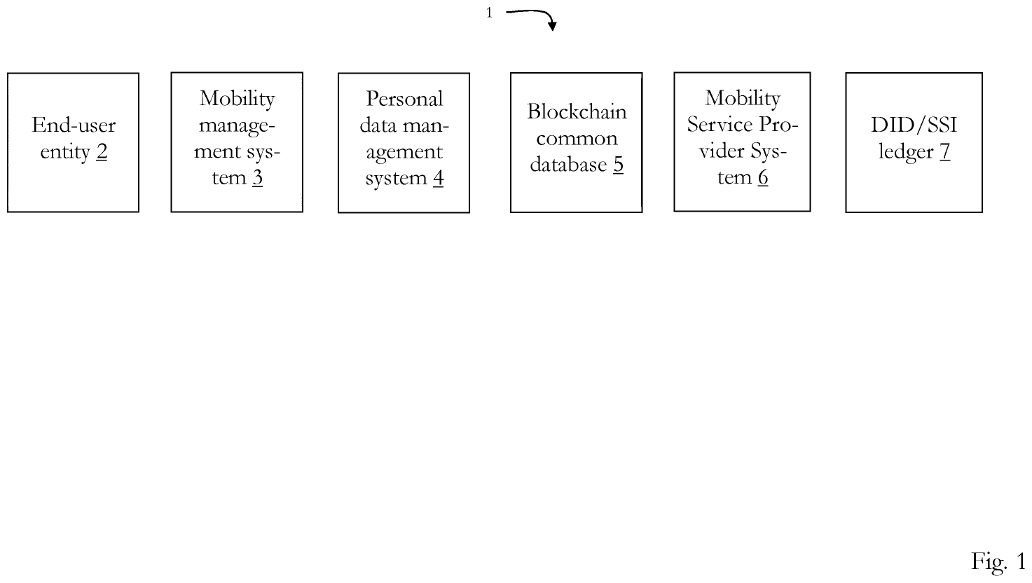

Before a detailed description of the embodiments starting with FIG. 1 is given, general explanations are made.

In the following, some terminology definitions are given, which may be applied in some embodiments (without limiting the present disclosure to the definitions given in the following. The definitions are only examples which are provided for enhancing the understanding of the present disclosure and which are only given, since the technology fields of MaaS and distributed ledgers are highly dynamical and definitions may change in the future.).

Environmental costs may refer to costs (monetary or other) which are connected with actual or potential deterioration of natural assets due to economic activities. Such costs may be defined differently depending on the circumstances. For example, as costs caused, i.e., costs associated with economic units actually or potentially causing environmental deterioration by their own activities, or as costs borne, i.e., costs incurred by economic units independently of whether they have actually caused the environmental impacts.

Emission may refer to release of greenhouse gas(es) (e.g., methane, carbon dioxide, nitrogen oxides, or the like) and/or precursors into the earth's atmosphere over a specified area and period of time.

Micromobility may refer to a range of small, lightweight vehicles operating at speeds typically below twenty-five km/h and driven by users personally (unlike rickshaws), such as bicycles, electric scooters, electric skateboards, shared bicycles, electric pedal assisted bicycles, or the like.

Marginal costs may refer to additional costs incurred in a production of one more unit of a good or service. It may be derived from a variable cost of production, given that fixed costs do not change as output changes, hence no additional fixed cost is incurred in producing another unit of a good or service once production has already started.

The term “distributed ledger” may be known from Wikipedia, which defines: “distributed ledger (also called a shared ledger, or distributed ledger technology, DLT) is a consensus of replicated, shared, and synchronized digital data geographically spread across multiple sites, countries, or institutions. There is no central administrator or centralized data storage.”

The technology of a distributed ledger and of a special example of it, namely of a blockchain, will also be discussed further below. More generally, the term distributed ledger is used as a type of database shared digitally recorded data with multiple nodes of a network. It may be comprised of peer to peer network. The digitally recorded data may include a kind of information to prove its consistency from the previously recorded data on the same database.

Distributed ledgers can be public and can be accessible by anyone, but, in principle, they can also be non-public and only users having a permission may have access to them, wherein a group of entities, nodes, persons, operators, providers or the like which have the permission may also referred to as “consortium”, as will also be explained further below. It is also possible to differentiate the access permission to data on a ledger from each layered users.

Distributed ledgers can use mechanisms, which are known, for example, from the blockchain technology as used for bitcoin. Such mechanisms include a discovery method, a consensus mechanism, a mechanism to keep data consistency and so on. The consensus mechanism ensures that all nodes or more than a certain number of nodes, generally electronic devices, having a copy of the distributed ledger reach consensus on the content of the distributed ledger. There are many consensus mechanisms including the so-called proof-of-work mechanism, which is some kind of crypto-puzzle and which ensures that, for example, older blocks of a blockchain cannot be changed (easily). For instance, proof-of-work is used for the mining process of the bitcoin blockchain.

In a distributed ledger or blockchain, a confirmation process to make a consensus about data renewal on a blockchain in attending nodes, called a mining process, may achieve irreversibility of the sequence of transactions recorded on the blockchain by including previous recorded data in the confirming data. Such mining process implements a distributed timestamp server for a new block of transactions. In bitcoin (and, thus, in some embodiments) the mining process is based on the SHA-256 hash function. Nodes of the blockchain that participate in the mining process search for a hash output with predefined properties while the input of the hash function depends on the current blocks of the blockchain and the new block of transactions to be added to the blockchain.

Proof-of-work computations based on hash functions may not be useful in themselves except that they are required to implement the irreversibility of the distributed ledger.

Moreover, generally, it is known to use a blockchain for storing a variety of data. For instance, images, videos, measurements, and text files can be recorded on the blockchain in the form of a transaction.

The term “Mobility as a service (MaaS)”, is also exemplarily known from Wikipedia, which defines: “Mobility-as-a-Service (MaaS) describes a shift away from personally-owned modes of transportation and towards mobility solutions that are consumed as a service. This is enabled by combining transportation services from public and private transportation providers through a unified gateway that creates and manages the trip, which users can pay for with a single account. Users can pay per trip or a monthly fee for a limited distance. The key concept behind MaaS is to offer travelers mobility solutions based on their travel needs.”

The term “mobility service provider” may be a catch-all name of any type of service provider MaaS. In some embodiments, it is typically a transport organization, such as railway companies, bus/coach, tram and taxi, car sharing, ride sharing, bike sharing and so on. Some of the mobility service providers may not provide the actual transport means, but may provide only a booking/arrangement, comparable to a travel agency or online booking site or the like. To a mobility service provider (or MaaS provider), it may also be referred to as “transport operator”, in some embodiments.

The term “passenger” may refer to a person who has a service contract with a home mobility service provider or which is a costumer of a home mobility service provider (defined below).

The term “user” may include a passenger or a different person which may book a journey for the passenger.

With MaaS, social problems may be tackled and customer experience may be improved.

Furthermore, it has been recognized that it may be possible to reduce environmental impact of transport (e.g. private or public transport) with MaaS.

Transport may be considered as an important factor in greenhouse gas emission like CO2 (carbon dioxide), or other greenhouse gases, such as nitrogen oxides. In addition, there may be other environmental impacts, such as road noise/noise from airplanes, consumption of natural resources like fuel, rare metal and the like, which are based on transport (public and/or private).

However, it may be not so easy for a passenger to be aware of actual environmental costs of the own journey. Statistics of transport may be available on a macro level such as for a city or a country, but the passenger may not know the impact of each journey for the environment: It has been recognized that there may be a need to visualize an environmental impact to the passenger on a micro level, e.g. an individual level (for each person or a group of persons), for each journey, for a set of journeys, per month, per transport type, or the like.

MaaS may help to improve awareness of the environmental impact on a micro level. As a result, a good visibility of the environmental impact may change the behavior of individual persons.

For example, different strategies may be applied for reducing an environmental impact, such as increasing passenger awareness of environmental costs (e.g., CO2 emission) of the journey and/or offering incentive(s) for a specific passenger behavior to reduce the environmental costs.

Therefore, some embodiments pertain to a communication network node comprising circuitry configured to: determine environmental costs of a user's journey based on journey data of the user and based on at least one route option for the journey.

The communication network node may include a computer, a server, a terminal device, or the like. Moreover, multiple of such components (e.g. several servers, which may also be coupled to terminal devices, and the like) may be envisaged. Generally, functions may be provided by software in a cloud service, such that this communication network node is not a physical node in some embodiments. The communication network node may be virtualized and, e.g., provided by a software-based solution. For example, the software-based functions could be deployed in the commercial cloud service (public cloud), in on-premise cloud (private cloud), in Multi-access Edge Computing (MEC) in the telecom network operator, and the like.

The communication network node and/or the circuitry may be used for a centralized database or a distributed ledger or a mixture of both.

Accordingly, in some embodiments the communication network node is further configured to: handle a distributed ledger.

In some embodiments, the communication network node is further configured to: handle a centralized database. FIG. 1 depicts a system overview 1 including a network node according to the present disclosure.

The system 1 includes a plurality of MaaS subsystems, such as an end-user entity 2 (e.g. a mobile/terminal device of a user), a mobility management system 2, a personal data management system (PDM) 3, a blockchain common database 4, a MaaS service provider system 5, and a DID ledger 6.

The end-user entity 2 may be configured to provide a user interface and a management of a mobility service to an end-user who has a contract with an MaaS servicer. The end-user entity 2 may include a smart phone application or a web service for the end-user, or the like.

For save and private (anonymous) use of MaaS, the following may be applied without limiting the present disclosure in that regard.

Some embodiments pertain to a terminal device including circuitry configured to: authenticate a user of the terminal device at a communication network node, such that the communication network node requests an anonymous identifier for providing an anonymous identification of the user to a mobility service provider, wherein the request is directed to a communication network node for providing a distributed ledger.

The end-user entity 2 (e.g. terminal device) may further provide at least one of the following functions, in some embodiments:
Sending a request of the end-user (including a destination) to an MaaS servicer.
Showing candidate routes, cost, journey time and so on from a start point to a destination point by the MaaS servicer.
Sending the selected result (i.e. the route which the user selected) to the MaaS servicer
Receiving the navigation data for the selected route and providing guidance to the end user.
The end user can confirm the additional payment if needed (e.g. beyond allowance of MaaS service like using taxi, first class).
During the journey, tracking the current end-user position and sending events of the journey, such as passing through the station gate, ride/arrival at the railway/tram/bus (at any other destination or with any other predetermined vehicle) and arrival at an intermediate point.
Detecting the arrival at a destination and starting (initiating) a finalization process of the journey when the end-user arrives at the destination.

The mobility management system 3 may be configured for coordination/negotiation with multiple transport operators (e.g. bus, tram, subways, railways, taxi, bike sharing, etc.), such that multi-modal mobility services may be provided.

In some embodiments, the mobility management system 3 may provide at least one of the following functions:
Finding the route/transport system based on an end-user request and/or other conditions like preferable transport system. It may search the multiple candidate routes (if more than one route) and provides them to end-user.
Matching the demand/supply between transport operator and end-user, for example finding a vacant seat, the variable tariff, e.g. based on peak status, or the like.
Decision of route and transport based on end-user selection/consent and/or booking/arranging a seat with the transport operator (if reservation is required).
Generating support information for the end-user and provide it to end-user entity like the route guidance, the navigation data, etc.
Tracking the user events and current status of journey during the journey (generally speaking: predetermined (journey) events are tracked). For example, if the end-user passes a station gate (e.g. based on NFC), it is detected and the event of the journey is generated, or any other journey events, as discussed herein.
The revenue sharing calculation among/with transport operators/mobility service providers when the journey is finished.

Accordingly, some embodiments pertain to a communication network node for providing a mobility management provider, including circuitry configured to: provide candidate routes to a user based on a request of the user which is issued based on an anonymous identifier for providing an anonymous identification of the user to a mobility service provider, wherein the anonymous identifier is generated based on a request of a personal data management provider to the distributed ledger.

The personal data management (PDM) system 4 may be configured for MaaS subscriber data management. It may be responsible for at least one of the following functions:
Handling MaaS services subscription/contract.
User authentication and/or authorization of MaaS service.
Handling of global unique DID and anonymous DID. Note that only the PDM 4 may know the relation between the global unique ID and anonymous ID. Hence the PDM 4 may also request the issuing of the anonymous ID.
Storing payment information (e.g. credit card information) and handling payment if requested.
Storing the preferences of end-user's journey/transport system. For example, preferable/non-preferable transportation system, (first) class usage, special conditions of the user like wheel-chair use, or the like.
Storing historical information of the journey. Updating the historical information when the journey is finished. Historical information may include at least one of frequent destinations, frequent start points, transit points, or the like.

Since the personal data may be sensitive, the PDM 4 may only share personal data in response to an agreement of the user of may not share the personal data at all.

Accordingly, some embodiments pertain to communication network node including circuitry configured to: request an anonymous identifier for providing an anonymous identification of a user of a mobility management provider to a mobility service provider, wherein the request is directed to a communication network node for providing a distributed ledger.

The blockchain common database 5 may be configured for reading/writing the MaaS transactions to/from distributed ledger (blockchain). A transaction may be recorded when an MaaS event is occurred.

For example, at least one of the following may be recorded/stored/carried out:
Anonymous DID (end-user ID)
Time/date stamp of the journey and/or contract and/or journey event
MaaS subscription/contract type (monthly based subscription, one day ticket, pay as you go and the like)
Validation of ticket right (e-ticket) if one-time ticket
Location/event (start point, transit, intermediate destination, final destination, passing the gate, ride/arrive the train, exit the station).
The journey beyond MaaS allowance (e.g. additional charge)
Transport cost and transport operator (mobility service provider) for revenue share calculation

Accordingly, some embodiments pertain to a communication network node for providing a distributed ledger, including circuitry configured to: store an anonymous identifier which is generate in a distributed ledger for providing an anonymous identification of a user of a mobility management provider to a mobility service provider, wherein the anonymous identifier is generated based on a request of a personal data management provider.

The mobility service provider system 6 may be configured for handling transport service operations in transport operators/MaaS servicers. The mobility service provider system 6 may further be configured for at least one of the following:
Accepting the anonymous DID.
Providing assistance information for end user's route selection. Finding the candidate route and timetable based on end user's input.
Booking the journey and issuing the ticket right (e-ticket) when end user selects the route.
Fare management. Calculating the fare of journey. Checking and recording the ride/arrival of transport system and pass the gate, validated e-ticket.
Recording a (journey) event during journey. For example, the transport operator detects the end-user passing the gate of railway station, such that the event is recorded in the common database.
Finalization of journey. When the journey is finished, a revenue sharing calculation is executed and recorded at the common blockchain database 5.

Accordingly, some embodiments pertain to a communication network node for providing a mobility service provider, including circuitry configured to: accept an anonymous identifier of a user for booking a journey with the mobility service provider, wherein the anonymous identifier is generated for providing an anonymous identification of the user of a mobility management provider to the mobility service provider, wherein the anonymous identifier is generated based on a request of a personal data management provider to a distributed ledger.

The DID/SSI ledger 7 may be configured for handling the DID issuance and verification of it requested by a third party.

DID/SSI ledger 7 may also be based on a blockchain for DID/SSI, but may be different from the common blockchain database 5. The DID/SSI ledger 7 may be responsible for at least one of the following:
Issuing of global unique DID for permanent use, and anonymous DID for temporary use.
Issuing of credential(s) (e.g. e-ticket, proof of MaaS subscription, proof of driving license, entry visa to a specific country, etc.) with global unique DID or anonymous DID.
Verification of credential requested by third party. For example, a railway company may check the validity of e-ticket, a car sharing company may check conditions of a driving license, or the like.
Invalidation/revoking of credential. For example, the end-user may have used a one-time e-ticket, a date is expired, the user may have quitted an MaaS service, or any other predetermined event.

Accordingly, the DID/SSI ledger 7 may correspond to the distributed ledger which issues the anonymous DID, as discussed above.

Some embodiments pertain to corresponding methods which, when the methods are carried out, cause respective entities to function as the entities as discussed herein, e.g., as a terminal device, a communication network node, or the like.

For example, some embodiments pertain to a method for providing a communication network node for providing a distributed ledger, the method including: generating an anonymous identifier for providing an anonymous identification of a user of a mobility management provider to a mobility service provider, wherein the anonymous identifier is generated based on a request of a personal data management provider to the distributed ledger.

Some embodiments pertain to a method for providing a communication network node, the method including: requesting an anonymous identifier for providing an anonymous identification of a user of a mobility management provider to a mobility service provider, wherein the request is directed to a communication network node for providing a distributed ledger.

Some embodiments pertain to a method for operating a terminal device, the method including: authenticating a user of the terminal device at a communication network node, such that the communication network node requests an anonymous identifier for providing an anonymous identification of the user to a mobility service provider, wherein the request is directed to a communication network node for providing a distributed ledger.

Some embodiments pertain to a method for providing a communication network node for providing a mobility management provider, the method including: providing candidate routes to a user based on a request of the user which is issued based on an anonymous identifier for providing an anonymous identification of the user to a mobility service provider, wherein the anonymous identifier is generated based on a request of a personal data management provider to the distributed ledger.

Some embodiments pertain to a method for providing a communication network node for providing a distributed ledger, the method including: storing an anonymous identifier which is generate in a distributed ledger for providing an anonymous identification of a user of a mobility management provider to a mobility service provider, wherein the anonymous identifier is generated based on a request of a personal data management provider.

Some embodiments pertain to a method for providing a communication network node for providing a mobility service provider, the method including: accepting an anonymous identifier of a user for booking a journey with the mobility service provider, wherein the anonymous identifier is generated for providing an anonymous identification of the user of a mobility management provider to the mobility service provider, wherein the anonymous identifier is generated based on a request of a personal data management provider to a distributed ledger.

As indicated above, some embodiments pertain to a communication network node comprising circuitry configured to: determine environmental costs of a user's journey based on journey data of the user and based on at least one route option for the journey.

Environmental costs may be a more general term for actual or potential costs caused by mobility. There may be direct costs and indirect costs. For example, CO2 emission may be defined by the unit, “CO2 kg/km per passenger”, similarly other emission gases like “NO2 kg/km per passenger”, or the like.

Such emissions may be measurable environmental factors and thus, such costs may be direct costs. In the case of greenhouse gases, their emission into air may be measured whereas for noise emission, a noise level of the specific transport (in dB) may be determined.

Indirect costs may refer to not measurable or difficultly measurable environmental factors, such as loss by traffic accidents, cause of traffic congestions, consumptions of hazardous material (e.g., lead for batteries), physical resources (e.g., land use for road construction), or the like.

Such indirect costs may be converted into quantities, such that their environmental impact may be determinable. For example, quantification may be based on a risk level, such as high risk of accident, medium risk, low risk, or the like.

Moreover, environmental costs may be calculated based on at least one predetermined coefficient.

For example, in the case of public transport, a direct (individual) measurement of CO2 emission may be challenging since public transport runs in line with a timetable regardless of a number of passengers.

In such cases, the CO2 emission may be averaged based on the number of passengers and/or the distance, such that the emission may be expressed in kilograms per person per kilometer, or the like (more general: amount per person per distance), for each transport.

In some embodiments, the communication network node is further configured to: use a pre-defined table for determining the environmental costs.

For example, a conversion table may be used for determining the CO2 emission, as it is generally known.

Also, micromobility may cause environmental costs although such costs may be small compared to other transport types. Generally, costs caused by micromobility may be considered to be zero (without limiting the present disclosure in that regard), but an acceptable distance for the passenger to use micromobility may be varying. For example, one passenger may accept a twenty minute walk (or bike ride), but another passenger may only accept a five minute walk (or bike ride).

Hence, it may not be possible in every instance to offer micromobility. Passenger's preferences on micromobility may be stored in the personal data management systems, such that a MaaS service provider may be able to offer it in line with the passenger's preferences.

In some embodiments, the environmental costs are determined based on at least one of a transport type, a distance, a journey time, an energy source, and an environmental cost coefficient.

In some embodiments, the environmental costs are determined for different suggested journeys for the user.

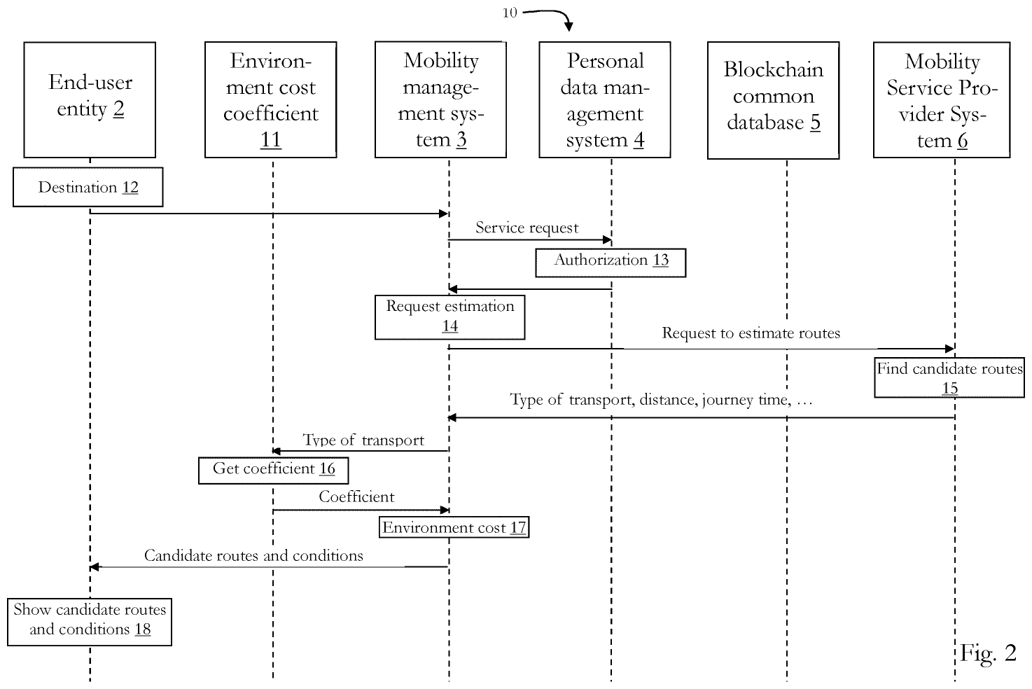

FIG. 2 depicts a method 10 according to the present disclosure, in which a route/transport selection is carried out based on environmental costs.

In this embodiment, the MaaS system shows the environmental cost for the passenger when the passenger selects the route/transport. In this embodiment, it is assumed that the environmental costs are predefined in a table and stored in a storage. Accordingly, the MaaS system includes an environmental cost database 11 storing the cost coefficients for calculation of the environmental cost.

At 12, an end-user (e.g., passenger) inputs a destination (and start point, e.g., if it is different from the current location).

The mobility management system 3 requests the service and requests authorization of it.

At 13, the personal data management system 4 authorizes the service if it is within the allowance of the user's MaaS contract. The personal data management system 4 may store the preference/history of previous journey and send them back to the mobility management system 3 in addition to the authorization result.

At 14, the mobility management system 3 requests the finding of candidate routes, cost estimation, estimated arrival time, and the like, to the mobility service provider system 6. It is requested to multiple transport operators, if there are multiple alternative routes/transport.

At 15, the mobility service provider system 6 finds the route and sends back the type of transport, routes, distance and other journey information like price, journey time which may be considered by the user.

The mobility management system 3 requests the coefficient of environmental cost in the database 11, which retrieves the coefficient at 16 and transmits it to the mobility management system 3.

The mobility management system 3 calculates the environmental cost for the journey, for example based on the formula coefficient (e.g., CO2 kg/passenger km)+distance of journey+number of passengers.

The mobility management system 3 sends the candidate routes and conditions including the environmental cost to end user entity 2 which shows the routes and conditions to the user, at 18, such that the user can compare the candidate routes and conditions including environmental cost and select it.

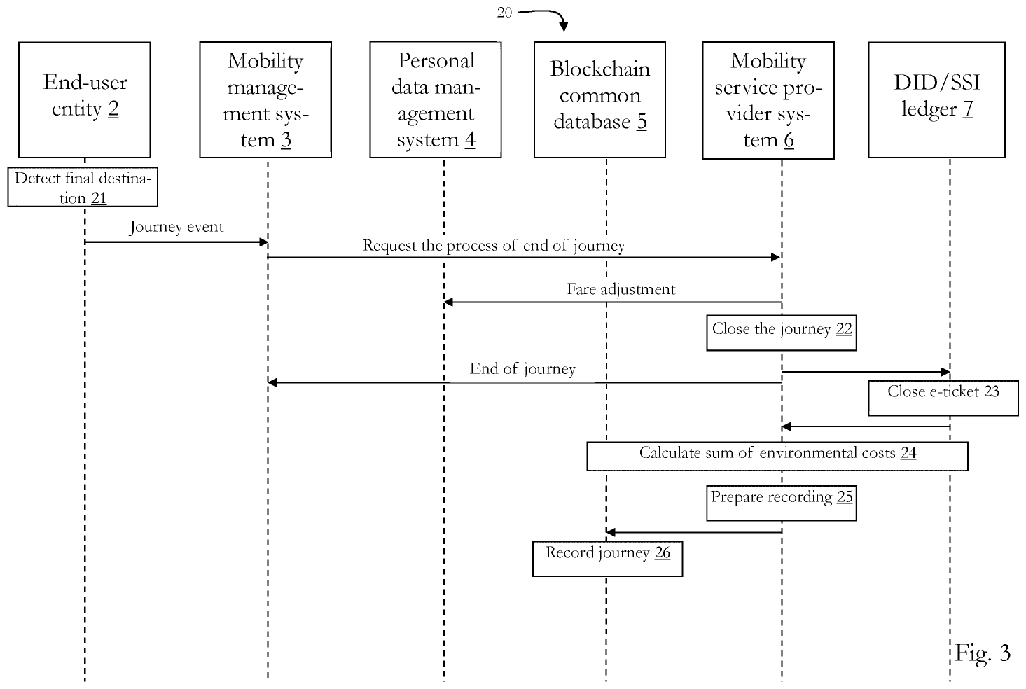

FIG. 3 shows an embodiment of a method 20 for recording environmental costs of a journey with a blockchain common database as an embodiment of a distributed ledger without limiting the present disclosure in that regard since any database may be used, such as a relational database, or the like.

When the passenger arrives at the final destination (detected by e.g., gate of railway station, geo-fencing detection in the destination area, or the like), at 21, the end user entity 2 sends an end of journey event to the mobility management system 3. Note that mobility service provide system may detect the end of journey if transport operator knows the arrival (e.g., air travel)

Thereupon, the mobility management system 3 sends the request to the process of end of journey to the mobility service provider system 6.

The mobility service provider system 6 closes the journey, at 22, and sends back the confirmation to end user. If additional payment or refund is needed, payment/adjustment may be processed with the personal data management system 4.

The mobility service provider system 6 closes the ticket and notifies the SSI/DID ledger 7 which closes the e-ticket, at 23.

Mobility service provider system 6 calculates the environmental costs for each journey based on the coefficient*distance*the number of passengers (the load of goods in case of goods transport).

At 25, the mobility service provider system 6 prepares the recoding of the journey (e.g., environmental cost, fare, time, transport provider, anonymous ID, and the like)

Mobility service provider writes the record to the common block chain database 5, at 26.

In some embodiments, the circuitry or the communication network node is further configured to: determine whether a total of environmental costs of the user in a predetermined time period exceeds a predetermined threshold.

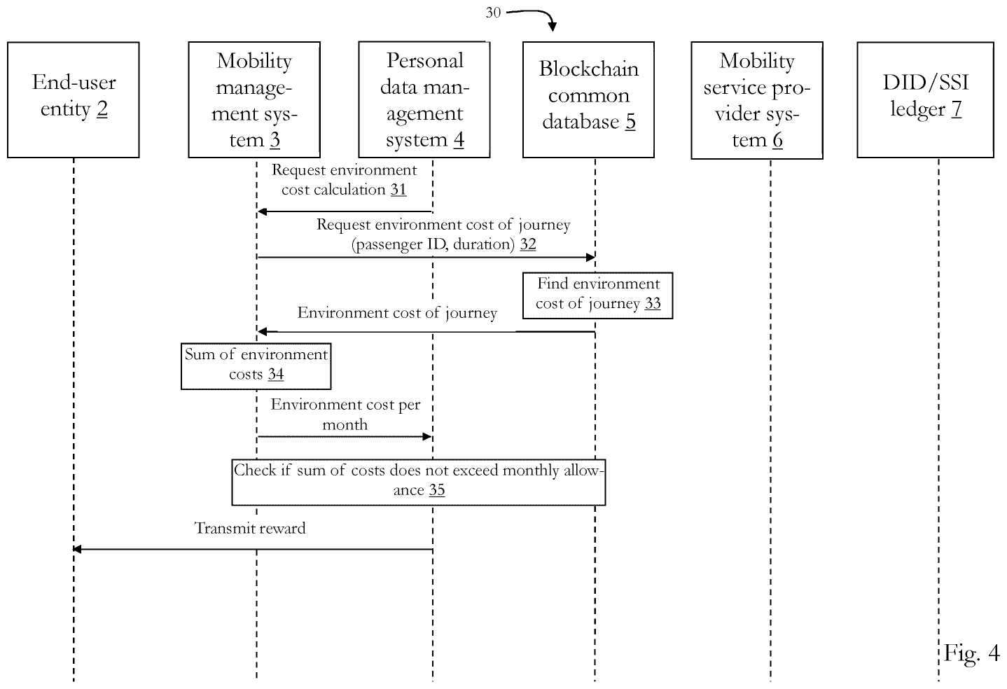

As indicated above, different strategies may be adopted to improve the user's environmental behavior. While with respect to FIGS. 2 and 3, the user is made aware of environmental costs, FIG. 4 provides a method 30 for providing environmental incentives to the user.

An incentive may be set by offering a discount to a ticket, for example, depending on the reduction level of environmental cost. Such a method may applicable for a pay-as-you-go based service.

However, a MaaS service may be on a monthly subscription basis, i.e., fixed price in a month. Hence, another method for providing an incentive may be based on a monthly allowance of environmental cost (or it could be yearly or daily, or the like). If the sum of environmental costs in a month has not reached the allowance, a reward (e.g., cash back) may be provided based on the difference between the allowance and the total environmental costs.

There may be many possible reward schemes like shopping discount, mileage program, and the like. In the following, it will not be focused on the reward scheme itself, but on how to get the sum of environmental cost in a month and check if it does not exceed the allowance.

In the method 30 of FIG. 4, at 31, the personal data management system 4 requests the monthly environmental costs at the mobility management system 3 with the passenger ID. Note that passenger ID in the blockchain may be anonymized, as described above, due to protection of personal identifiable information.

At 32, the mobility management system 3 requests the record of the journey including the environmental costs with the passenger ID and duration (e.g., from April 1st to April 30th) the common blockchain database 5. If the data is stored in different databases, this process may be repeated multiple times.

The blockchain database 5 retrieves the record of previous journeys with the passenger ID and the duration, at 33.

The mobility management system 3 calculates the sum of the environmental costs, at 34.

The mobility management system 3 informs the personal data management system 4 of the result (sum of monthly environmental costs).

Personal data management system check if the sum of monthly environmental costs exceeds the monthly allowance.

Personal data management system 4 provides the reward if the sum of costs does not exceed the allowance, which is checked at 35.

In some embodiments, the communication network node and/or the circuitry is further configured to: obtain energy data from an energy provider network node.

In some embodiments, the communication network node and/or the circuitry is further configured to: communicate with an environment cost database network node for recording energy data.

In some embodiments, the communication network node and/or the circuitry is further configured to: obtain an environmental cost coefficient for determining the environmental costs.

In some embodiments, the environmental cost coefficient is obtained based on a transport type of the journey.

In contrast to the instance described above, the environmental cost coefficient does not necessarily need to be fixed (i.e., obtained from a table).

Actual environmental costs may depend on various factors, such as type of energy, type, or road (e.g., motorway or not), type of car, type of engine, and so on. Fixed values may be a too simplified approach, in some embodiments, whereas realistic values may be considered, as described in the following.

For example, environmental cost coefficients may be defined dynamically based on actual energy consumption or operation conditions. Moreover, there may be hidden environmental costs. For example, the electric car may appear to have zero emission of CO2 compared to the conventional car with an internal combustion engine. However, the generation of electricity may use fossil fuel, such that indirectly, also electric cars may produce CO2 emission.

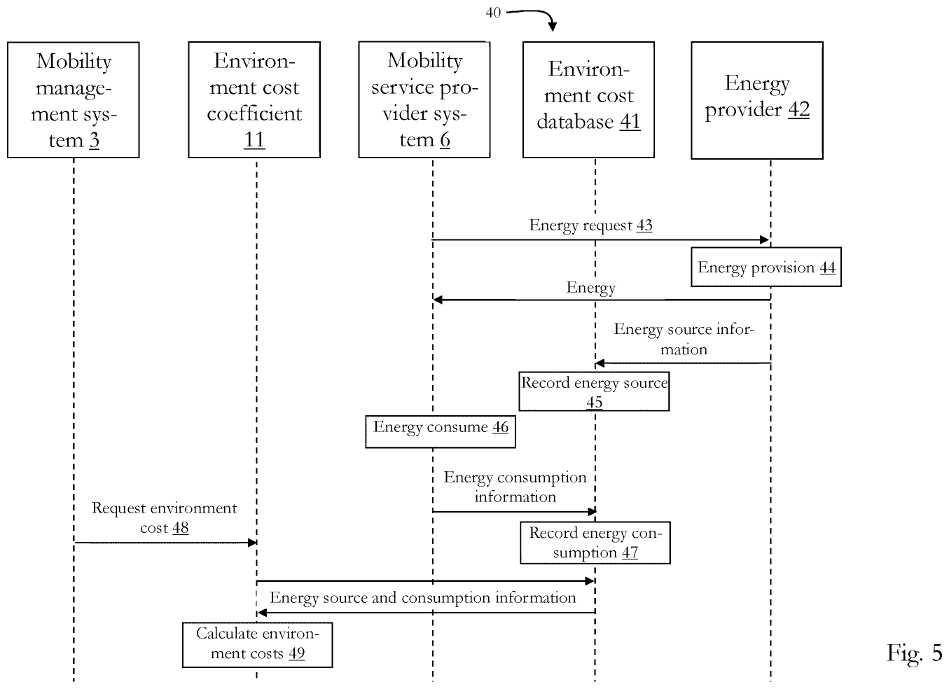

Accordingly, FIG. 5 depicts a method 40 for determining individual environmental costs.

At 43, the mobility service provider system 6 (e.g., railway company) requests the energy (e.g., electricity, diesel, fuel, or the like) at an energy provider 42 (e.g., electricity company).

At 44, the energy provider 42 provides the energy to the mobility service provider system 6.

Moreover, at 45, the energy provider 42 records the energy source information in an energy database 41. Exemplarily, the following data may be recorded: type of energy (e.g., electricity, diesel fuel); amount of fuel; additional information on environmental cost (for example, if the electricity is generated by fossil fuel, the CO2 emission by it); Mobility service provider consume the energy (e.g., running the train).

At 46, the mobility service provider system 6 records the consumption of energy. Exemplarily, the following data may be stored: energy consumption; type of fuel (e.g., electricity, diesel fuel); amount of consumption; emission conversion values (for example, for internal combustion engine, environmental cost depends on the type of car, type of engine and so on. For example, old diesel engine may emit more CO2 or NOx than new type diesel engine); additional information for environmental cost calculation; distance of journey; the number of passengers and/or amount of goods; noise level.

The mobility service provider system 6 determines the energy consumption, transmits it to the environment cost database, which records the energy consumption, at 47, as well. In this embodiment, the environment cost database is based on a distributed ledger (DLT). However, according to the present disclosure, it may additionally or alternatively be based on a centralized database like relational database service (RDS).

Moreover, the mobility management system 3 requests, at 48, the environmental cost coefficient at the environmental cost database 41 (e.g., via environment coefficient database or directly)

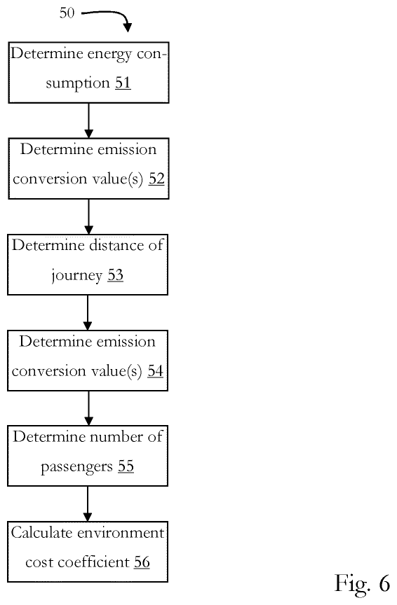

The environmental cost database 41 provides the energy source information and energy consumption information to the environment cost coefficient database 11, which then calculates the environmental cost coefficient, at 49, as described with respect to FIG. 6.

Then, the environment cost coefficient database 11 provides the environmental cost coefficient to mobility management system.

FIG. 6 depicts a flowchart of how the environment cost coefficient database 11 determines the environmental cost coefficient.

At 51, the energy consumption is obtained from the environmental cost database 41.

At 52, the emission conversion values are obtained from the environmental cost database 41.

If internal combustion engine, the ratio of CO2 or other emissions (e.g., kg) vs fuel consumption (k liter) may be determined. If electric engine, the ratio of CO2 emission by original electricity generation vs electricity consumption may be determined, or the like.

At 53, the distance of journey is obtained from the environmental cost database 41.

At 54, the emission conversion value is obtained.

At 55, the number of passengers is obtained from the environmental cost database 41.

If it is not countable, a capacity of passengers in the vehicle (i.e., assuming the vehicle is full) is used instead.

At 56, the environmental cost coefficient is calculated by:

cost coefficient=Total Emission(s)/(distance of journey*number of passengers)

In some embodiments, the communication network node and/or the circuitry is further configured to: determine a capacity of the transport type.

In some embodiments, the communication network node and/or the circuitry is further configured to: determine a number of passengers; and determine, based on the number of passengers, whether an increase of the capacity is indicated.

In some embodiments, the communication network node and/or the circuitry is further configured to: determine, based on at least one of the number of passengers, the transport type, and the capacity, whether a change of the transport type leads to a decrease of the environmental costs.

In some embodiments, the communication network node and/or the circuitry is further configured to: offer an alternative transport, if the environmental costs can be decreased thereby.

In some embodiments, the environmental cost coefficient is determined based on at least one of an energy consumption, an emission conversion value, a journey distance, and a number of passengers.

In some embodiments, the communication network node and/or the circuitry is further configured to: offer a conditional booking based on an expected future number of passengers and based on the expected environmental costs per future number of passengers.

In some embodiments, marginal costs are taken into account for optimizing environmental costs calculation.

It has been recognized that there are instances in which public transport is not as environmental friendly as using a private car, for example.

For example, the public transport is not so flexible (e.g., since it is operated based on a fixed timetable) and the capacity is not so dynamically changeable.

For example, if everyone uses a car (the capacity is e.g., five persons per car), the increasing trend of CO2 emission is almost linear, as can be taken from FIG. 7 depicting a diagram 60 showing a CO2 emission versus a number of passengers when using a car.

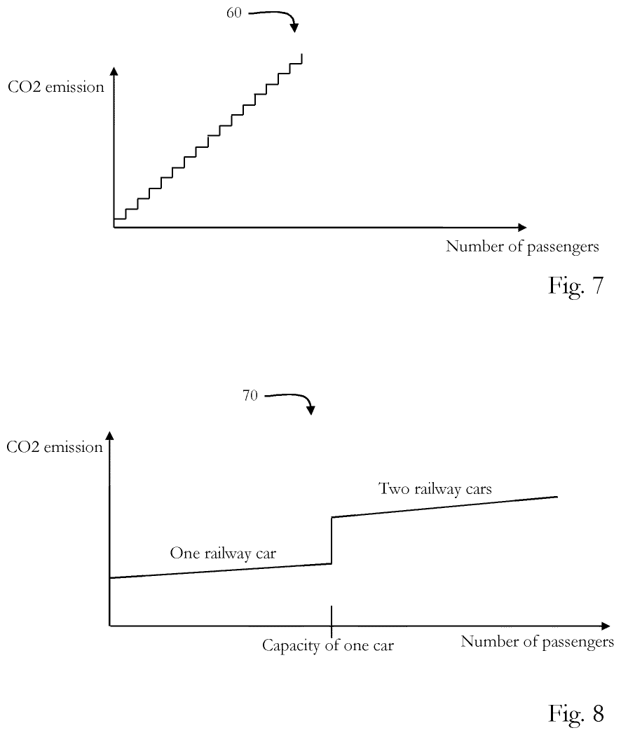

In contrast to that, FIG. 8 shows a similar diagram 70, but not for a private car, but for a railway. One railway car may have a capacity of a hundred passengers and if the railway car is full, another one has to be added.

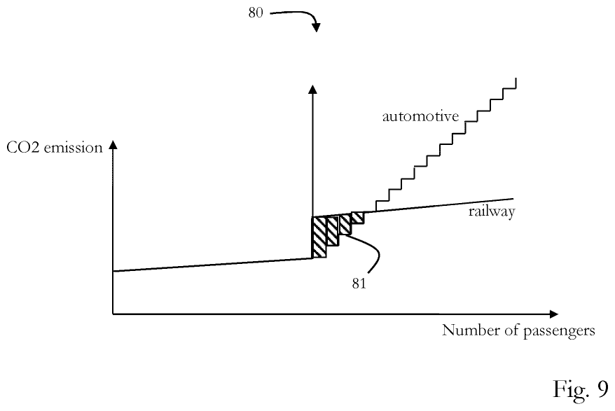

In FIG. 9, an overlay diagram 80 is shown overlaying the graphs of FIG. 7 and FIG. 8, such that they may be compared. There is a region 81, in which it produces less CO2 emission when only cars are used.

In such cases, a MaaS system according to the present disclosure may suggest using automotive rather than railway in that region, if it can be predicted that not enough passengers will take the train. In such a case, other routes/transport and/or other incentives may be presented to the user, or the like.

Based on this, key requirements for taking marginal costs into account may be identified, such as the following:
MaaS mobility servicer initially may not know the additional cost for increasing the passenger number. Mobility service provider (e.g., railway company) may know it.
MaaS mobility servicer may offer a passenger the low environmental cost transport based on the marginal costs.
The whole transport system may be optimized rather than just one MaaS servicer.

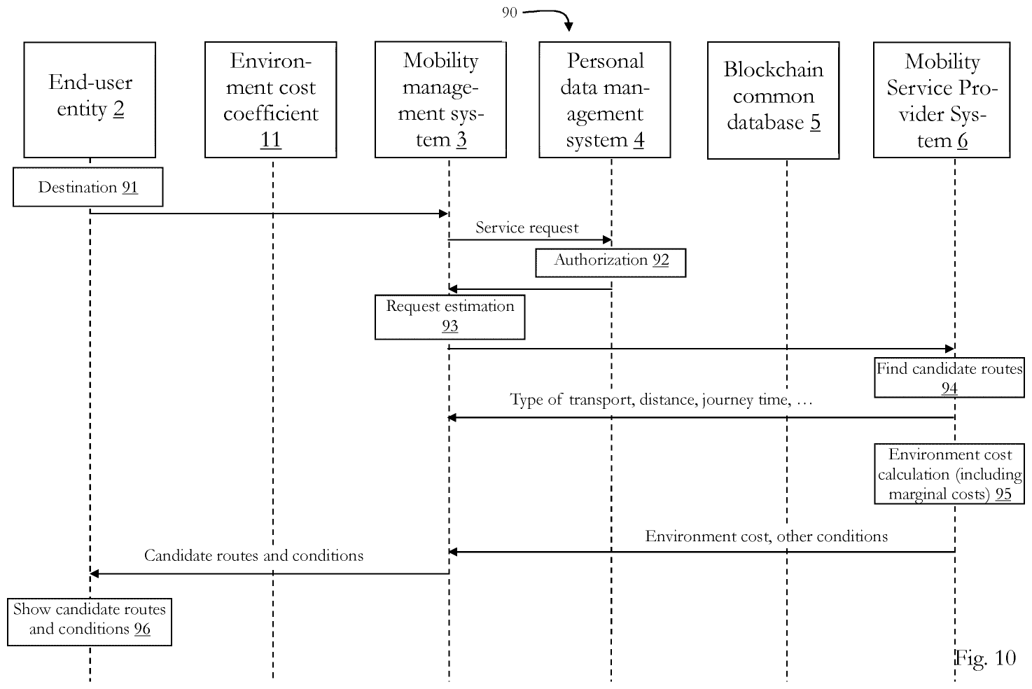

Based on such a modified marginal cost determination, FIG. 10 depicts a method 90 which takes these insights into account.

At 91, the end-user inputs the destination (and start point if it is different from the current location).

Then, the mobility management system 3 requests the service and requests authorization of it.

At 92, the personal data management system 4 authorizes the service if it is within the allowance of contract. The personal data management system 4 may store the preference/history of previous journey and send them back to the mobility management system 3 in addition to the authorization result.

At 93, the mobility management system 3 requests the finding of candidate route, cost estimation, estimated arrival time, and the like at the mobility service provider system 6. It is requested to multiple transport operators if there are multiple alternative routes/transport.

At 94, the mobility service provider system 6 retrieves the route(s) and sends back type of transport, routes, distance and other journey information like price, journey time which are useful for the end-user's decision.

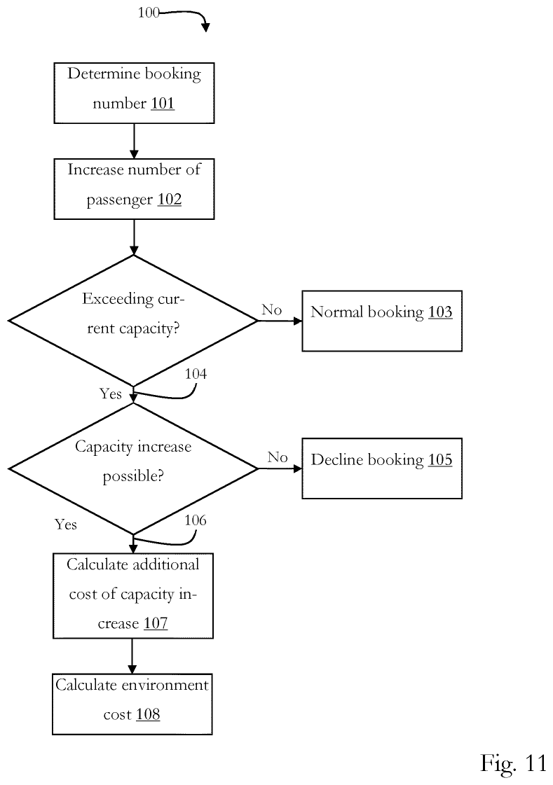

At 95, the mobility service provider system 6 determines the environmental cost with marginal cost, as will further be described under reference of FIG. 11.

The mobility service provider system 6 may offer the conditional booking in case the number of passengers is not large enough when it is requested, as will further be described under reference of FIG. 12.

The mobility service provider system 6 sends the environmental cost and conditions to the mobility management system 3.

The mobility management system 6 sends the candidate routes and conditions to the end-user entity 2. Mobility management system may change the transport and/or environmental cost.

The end-user entity 2 shows the candidate routes and conditions at 96, such that the end-user can compare the candidate routes and conditions and select one.

FIG. 11 depicts a flowchart of a method 100 for calculating environmental costs.

At 101, a booking number is obtained (or estimated from historical information of the user).

At 102, the number of passengers is increased.

After that, it is decided whether the number of passengers exceeds the current transport capacity? If not, at 103, a normal booking is carried out.

If yes, 104, it is determined whether a capacity increase is possible.

If not, the booking is declined, at 105.

If yes, 106, additional costs of the capacity increase are determined, at 107.

At 108, environmental costs are calculated, as described herein.

FIG. 12 depicts a flowchart of a method 110 for offering a conditional booking of a journey for deciding whether a capacity increase may be carried out.

The mobility service provider (public transport operators like railway companies, bus companies) may not immediately be able to decide to increase the capacity. They may decide it depending on the demand later.

In the case of MaaS, public transport may change more flexible according to the demand rather than pre-define timetable operations. Hence, the mobility service provider may offer a conditional booking. If the demand is high enough, they increase the capacity.

First, it is decided whether a calculated cost per passenger is too high. If it is not too high, normal booking is carried out, at 111.

If yes, 112, a future booking number is predicted. For example, statistics from historical information may be used or an AI model may be utilized. If the predicted number is not sufficiently high, it may be decided that the capacity may not be increased.

If the predicted number is high enough, a conditional booking may be offered.

As discussed above, environmental costs may be lower in some instances when using a car due to marginal costs. In such cases, the MaaS service provider may offer a car (e.g., taxi, bus, car-pool) instead of a railway ticket, or the like.

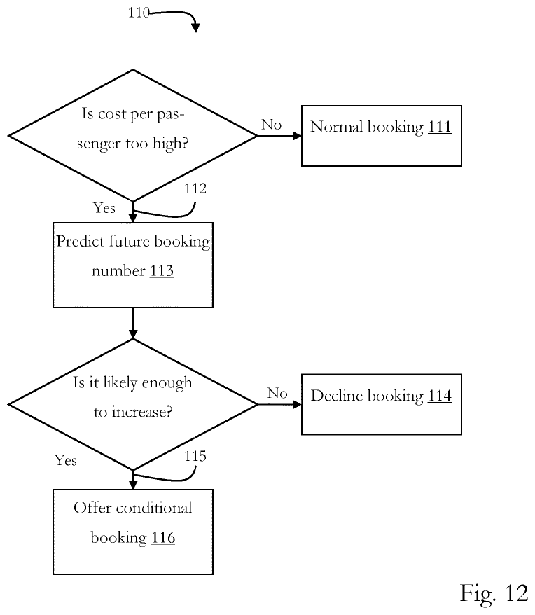

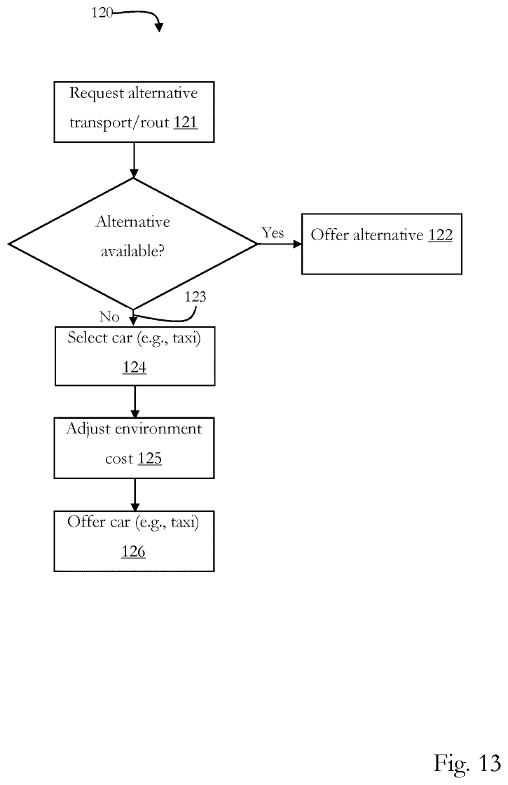

Such a process is shown in FIG. 13 depicting a method 120.

At 121, alternative transport/routes are requested at other mobility service providers (railway companies, tram operators, bus operators, or the like).

If alternatives are available, these are offered, at 122.

If not, 123, a car (or another transport type) may be offered, at 124.

At 125, environmental costs are adjusted. The environmental cost of the car should not exceed that of the public transport.

At 126, the car is offered with the modified the environmental cost.

Some embodiments pertain to a method carried out in a communication network node, the method including: determining environmental costs of a user's journey based on journey data of the user and based on at least one route option for the journey, as discussed herein.

The method may be carried out by one or more communication network nodes and/or corresponding circuitry.

In some embodiments, the environmental costs are further determined based on at least one of a transport type, a distance, a journey time, an energy source, and an environmental cost coefficient, as discussed herein. In some embodiments, the environmental costs are determined for different suggested journeys for the user, as discussed herein. In some embodiments, the method further includes determining whether a total of environmental costs of the user in a predetermined time period exceeds a predetermined threshold, as discussed herein. In some embodiments, the method further includes obtaining energy data from an energy provider network node, as discussed herein. In some embodiments, the method further includes communicating with an environment cost database network node for recording energy data, as discussed herein. In some embodiments, the method further includes obtaining an environmental cost coefficient for determining the environmental costs, as discussed herein. In some embodiments, the environmental cost coefficient is obtained based on a transport type of the journey, as discussed herein. In some embodiments, the method further includes determining a capacity of the transport type, as discussed herein. In some embodiments, the method further includes: determining a number of passengers; and determining, based on the number of passengers, whether an increase of the capacity is indicated, as discussed herein. In some embodiments, the method further includes determining, based on at least one of the number of passengers, the transport type, and the capacity, whether a change of the transport type leads to a decrease of the environmental costs, as discussed herein. In some embodiments, the method further includes offering an alternative transport, if the environmental costs can be decreased thereby, as discussed herein. In some embodiments, the environmental cost coefficient is determined based on at least one of an energy consumption, an emission conversion value, a journey distance, and a number of passengers, as discussed herein. In some embodiments, the method further includes offering a conditional booking based on an expected future number of passengers and based on the expected environmental costs per future number of passengers, as discussed herein. In some embodiments, the method further includes: handling a distributed ledger with the communication network node, as discussed herein. In some embodiments, the method further includes handling a centralized database with the communication network node, as discussed herein. In some embodiments, the method further includes using a pre-defined table for determining the environmental costs, as discussed herein.

Some embodiments pertain to user equipment configured to communicate with a communication network node, the user equipment including circuitry configured to: obtain environmental costs of a user's journey which are determined based on journey data of the user and based on at least one route option for the journey, as discussed herein.

In some embodiments, the user equipment is further configured to provide a destination to the communication network node for determining the environmental costs of the journey, as discussed herein. In some embodiments, the user equipment is further configured to provide candidate routes associated with the environmental costs for each candidate route to a user, as discussed herein. In some embodiments, the user equipment is further configured to offer a reward to the user associated with at least one candidate route, as discussed herein.

Some embodiments pertain to a method carried out in user equipment configured to communicate with a communication network node, the method including: obtaining environmental costs of a user's journey which are determined based on journey data of the user and based on at least one route option for the journey, as discussed herein.

In some embodiments, the method further includes providing a destination to the communication network node for determining the environmental costs of the journey, as discussed herein. In some embodiments, the method further includes providing candidate routes associated with the environmental costs for each candidate route to a user, as discussed herein. In some embodiments, the method further includes offering a reward to the user associated with at least one candidate route, as discussed herein.

Some embodiments pertain to a communication system including communication network nodes and circuitry configured to: determine environmental costs of a user's journey based on journey data of the user and based on at least one route option for the journey, as discussed herein.

In some embodiments, the communication system is further configured to record the journey in a blockchain, as discussed herein. In some embodiments, the communication system is further configured to determine the environmental costs in a first subset of the communication network nodes, as discussed herein. In some embodiments, the communication system is further configured to determine, in a second subset different from the first subset of the communication network nodes, whether a total of environmental costs of the user in a predetermined time period exceeds a predetermined threshold, as discussed herein. In some embodiments, the communication system is further configured to: handle a distributed ledger, as discussed herein. In some embodiments, the communication system is further configured to: handle a centralized database, as discussed herein. In some embodiments, the communication system is further configured to: use a pre-defined table for determining the environmental costs, as discussed herein.

Some embodiments pertain to a method carried out in a communication system including communication network nodes, the method including: determining environmental costs of a user's journey based on journey data of the user and based on at least one route option for the journey, as discussed herein. In some embodiments, the method further includes as discussed herein. In some embodiments, the method further includes recording the journey in a blockchain as discussed herein. In some embodiments, the method further includes determining the environmental costs in a first subset of the communication network nodes determining, in a second subset different from the first subset of the communication network nodes, whether a total of environmental costs of the user in a predetermined time period exceeds a predetermined threshold, as discussed herein. In some embodiments, the method further includes handling a distributed ledger with the communication network node, as discussed herein. In some embodiments, the method further includes handling a centralized database with the communication network node, as discussed herein. In some embodiments, the method further includes using a pre-defined table for determining the environmental costs, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

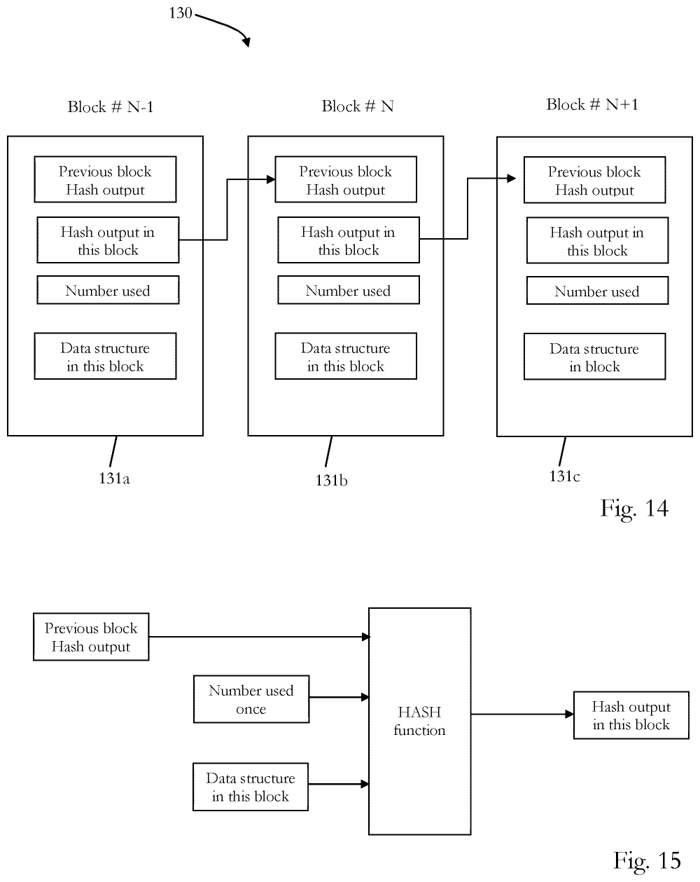

In the following a blockchain and its general data structure will be explained under reference of FIG. 14. In this embodiment of a blockchain, features are a network/topology, a consensus algorithm a Hash function, participant authentication, a scalability/block structures and performance.

FIG. 14 illustrates a general structure of a blockchain 130. The blockchain 130 includes a chain of multiple data blocks 131a, 131b and 131c, wherein the block 131b is a current block (Block #N), the block 131a is a previous block (Block #N−1) and the block 131c is a future or successor block (Block #N+1). Each block includes a hash function result of a previous block, a main data structure, an input value for hash function and hash function result of the current block, wherein the hash function result of current block (131b) is always used as input to the next block (131c).

Moreover, each block includes a “Number used once”, which is a one-shot random number for a secure blockchain processing, and which can prevent replay attack. For instance, if an attacker copies the previous transmitted data and reuses the copied data again for spoofing, the receiver is able to detect the spoofing communication because the next data must be used with a different “number used once”. This random number is sometimes referred to as “nonce” in cryptocurrency.

Additionally, the time stamp may be inserted in each of the blocks 131a, 131b and 131c. The blockchain 130 is an example of a distributed ledger, which may be used, for example, for providing MaaS in some embodiments.

FIG. 15 illustrates the input and output of a hash function, which is used, for example, for the blockchain 130 of FIG. 14.

Generally, a hash function is any function that can be used to map input data to output data with a specific algorithm. The size of input data can be large and various, contrarily the output of data could be compact and can have a fixed size. A known (and famous) algorithm which is used for hashing in some blockchain embodiments is the Secure Hash Algorithm (SHA) designed by the United States National Security Agency (e.g. SHA-2, SHA-256).

The input for the hash function are a previous hash output, the number used once and the main body of data in the current block (e.g. block 131b in FIG. 14). The output of the hash function is a unique value response to the input values. If someone tries to tamper the main body of data, the output of hash function cannot be consistent.

Embodiments of a distributed ledger (blockchain) in this disclosure may implement a consensus protocol or algorithm. For instance, in some embodiments, the Byzantine Fault Tolerance (BFT) is used for the consensus protocol, which is resilient to spoofing of database and fault of hardware.

A well-known consensus algorithm, which is implemented in some embodiment, is the so-called Practical Byzantine Fault Tolerance (PBFT).

In some embodiments, a permission blockchain is used and the relatively small number of permissioned blockchain nodes are in charge of consensus (validation of block).

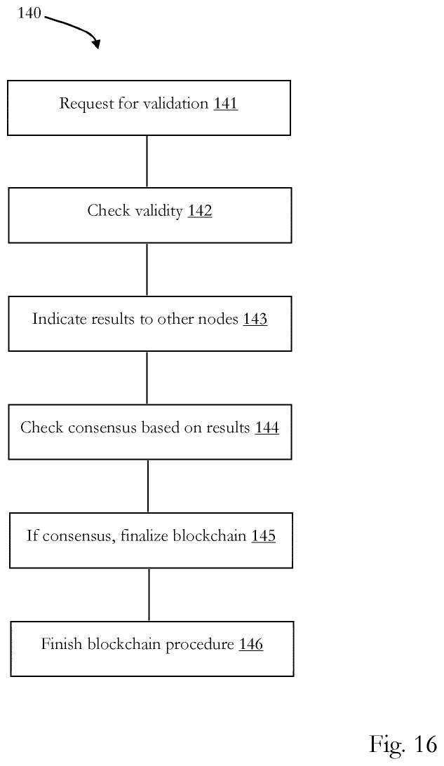

FIG. 16 exemplary illustrates a process 140 of PBFT.

A leader node (it also called non-validating peer) requests at 141 other nodes to validate the blockchain. At 142, each requested node (validate peer) checks the validity of the blockchain with a hash function and indicates its result to other nodes at 143. At 144, a node receives the validity results from multiple other peers and checks the consensus of the blockchain, if it receives more valid results than a pre-defined criteria. If there is a consensus, at 145, the node writes/finalizes the blockchain. A leader peer checks the overall progress of the validity check in other nodes and finishes at 146 the blockchain procedure.

For resilience, the total number of nodes is more than 3f+1 in some embodiments, wherein f is the number of allowed failure nodes. For example, f=1, there is a total 4 nodes; if f=3, there is a total of 10 nodes, etc.

In some embodiments, the PBFT is with permission blockchains for mobility service blockchains, as discussed herein, providing at least partially the following features:

With respect to security, the PBFT provides in some embodiments a little risk of 51% attack, which is common for cryptocurrency because permission the peer which is in charge of consensus must be trusted. With respect to privacy, the end user cannot access the whole blockchain because only mobility service providers handle it at a (peer) node (due to the permission based blockchain and end users may not have the permission to access the blockchain). With respect to performance, the processing time for consensus is very short in some embodiments due to a small number of peers having a high performance. With respect to flexibility, the block size and format of blockchains can be flexible compared to public blockchains in some embodiments.

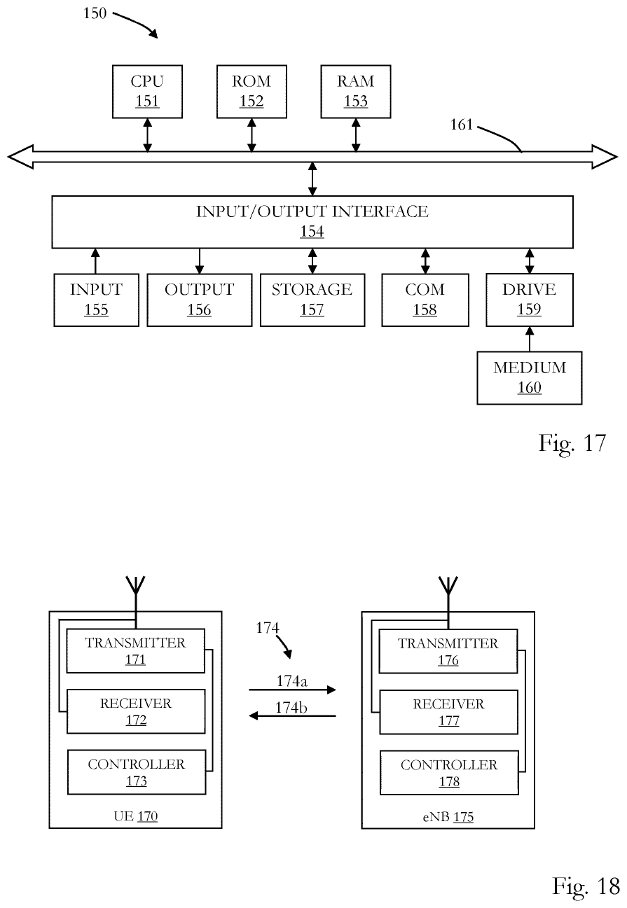

In the following, an embodiment of a general purpose computer 150 is described under reference of FIG. 17. The computer 150 can be implemented such that it can basically function as any type of network equipment, e.g. a network node, an identity hub, a part of a decentralized database, a base station or new radio base station, transmission and reception point, or communication device, such as user equipment, (end) terminal device or the like. The computer has components 151 to 161, which can form a circuitry, such as any one of the circuitries of the network equipments and communication devices, as described herein.

Embodiments which use software, firmware, programs or the like for performing the methods as described herein can be installed on computer 150, which is then configured to be suitable for the concrete embodiment.

The computer 130 has a CPU 151 (Central Processing Unit), which can execute various types of procedures and methods as described herein, for example, in accordance with programs stored in a read-only memory (ROM) 152, stored in a storage 157 and loaded into a random access memory (RAM) 153, stored on a medium 160 which can be inserted in a respective drive 159, etc.

The CPU 151, the ROM 152 and the RAM 153 are connected with a bus 161, which in turn is connected to an input/output interface 154. The number of CPUs, memories and storages is only exemplary, and the skilled person will appreciate that the computer 150 can be adapted and configured accordingly for meeting specific requirements which arise, when it functions as a base station or as user equipment (end terminal).

At the input/output interface 154, several components are connected: an input 155, an output 156, the storage 157, a communication interface 158 and the drive 159, into which a medium 160 (compact disc, digital video disc, compact flash memory, or the like) can be inserted.

The input 155 can be a pointer device (mouse, graphic table, or the like), a keyboard, a microphone, a camera, a touchscreen, etc.

The output 156 can have a display (liquid crystal display, cathode ray tube display, light emittance diode display, etc.), loudspeakers, etc.

The storage 157 can have a hard disk, a solid state drive and the like.

The communication interface 158 can be adapted to communicate, for example, via a local area network (LAN), wireless local area network (WLAN), mobile telecommunications system (GSM, UMTS, LTE, NR etc.), Bluetooth, infrared, etc.

It should be noted that the description above only pertains to an example configuration of computer 150. Alternative configurations may be implemented with additional or other sensors, storage devices, interfaces or the like. For example, the communication interface 158 may support other radio access technologies than the mentioned UMTS, LTE and NR.

When the computer 150 functions as a base station, the communication interface 158 can further have a respective air interface (providing e.g. E-UTRA protocols OFDMA (downlink) and SC-FDMA (uplink)) and network interfaces (implementing for example protocols such as S1-AP, GTP-U, S1-MME, X2-AP, or the like). Moreover, the computer 130 may have one or more antennas and/or an antenna array. The present disclosure is not limited to any particularities of such protocols.

An embodiment of a user equipment UE 170 and an eNB 175 (or NR eNB/gNB) and a communications path 174 between the UE 170 and the eNB 175, which are used for implementing embodiments of the present disclosure, is discussed under reference of FIG. 18. The UE 170 is an example of a communication device (or end-user entity) and the eNB is an example of a base station (e.g. a network node), without limiting the present disclosure in that regard.

The UE 170 has a transmitter 171, a receiver 172 and a controller 173, wherein, generally, the technical functionality of the transmitter 171, the receiver 172 and the controller 173 are known to the skilled person, and, thus, a more detailed description of them is omitted.

The eNB 175 has a transmitter 176, a receiver 177 and a controller 178, wherein also here, generally, the functionality of the transmitter 176, the receiver 177 and the controller 178 are known to the skilled person, and, thus, a more detailed description of them is omitted.

The communication path 174 has an uplink path 174a, which is from the UE 170 to the eNB 175, and a downlink path 174b, which is from the eNB 175 to the UE 170.

During operation, the controller 173 of the UE 170 controls the reception of downlink signals over the downlink path 174b at the receiver 172 and the controller 173 controls the transmission of uplink signals over the uplink path 174a via the transmitter 171.

Similarly, during operation, the controller 158 of the eNB 175 controls the transmission of downlink signals over the downlink path 174b over the transmitter 176 and the controller 178 controls the reception of uplink signals over the uplink path 174a at the receiver 177.

It should be recognized that the embodiments describe methods with an exemplary ordering of method steps. The specific ordering of method steps is however given for illustrative purposes only and should not be construed as binding. For example the ordering of 52 and 53 in the embodiment of FIG. 6 may be exchanged. Also, the ordering of 101 and 102 in the embodiment of FIG. 11 may be exchanged. Further, also the ordering of 45 and 47 in the embodiment of FIG. 5 may be exchanged. Other changes of the ordering of method steps may be apparent to the skilled person.

Please note that the division of the computer 150 into units 151 to 153 is only made for illustration purposes and that the present disclosure is not limited to any specific division of functions in specific units. For instance, the computer 150 could be implemented by a respective programmed processor, field programmable gate array (FPGA) and the like.

The methods described herein can also be implemented as a computer program causing a computer and/or a processor, such as processor 151 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A communication network node comprising circuitry configured to:
   determine environmental costs of a user's journey based on journey data of the user and based on at least one route option for the journey.
(2) The communication network node of (1), wherein the environmental costs are further determined based on at least one of a transport type, a distance, a journey time, an energy source, and an environmental cost coefficient.
(3) The communication network node of (1) or (2), wherein the environmental costs are determined for different suggested journeys for the user.
(4) The communication network node of anyone of (1) to (3), further configured to:
   determine whether a total of environmental costs of the user in a predetermined time period exceeds a predetermined threshold.
(5) The communication network node of anyone of (1) to (4), further configured to:
   obtain energy data from an energy provider network node.
(6) The communication network node of anyone of (1) to (5), further configured to:
   communicate with an environment cost database network node for recording energy data.
(7) The communication network node of anyone of (1) to (6), further configured to:
   obtain an environmental cost coefficient for determining the environmental costs.
(8) The communication network node of (7), wherein the environmental cost coefficient is obtained based on a transport type of the journey.
(9) The communication network node of (8), further configured to:
   determine a capacity of the transport type.
(10) The communication network node of (9), further configured to:
   determine a number of passengers; and
   determine, based on the number of passengers, whether an increase of the capacity is indicated.
(11) The communication network node of (10), further configured to:
   determine, based on at least one of the number of passengers, the transport type, and the capacity, whether a change of the transport type leads to a decrease of the environmental costs.
(12) The communication network node of (11), further configured to:
   offer an alternative transport, if the environmental costs can be decreased thereby.
(13) The communication network node of anyone of (7) to (12), wherein the environmental cost coefficient is determined based on at least one of an energy consumption, an emission conversion value, a journey distance, and a number of passengers.
(14) The communication network node of anyone of (1) to (13), further configured to:
   offer a conditional booking based on an expected future number of passengers and based on the expected environmental costs per future number of passengers.
(15) The communication network node of anyone of (1) to (14), further configured to:
   handle a distributed ledger.
(16) The communication network node of anyone of (1) to (15), further configured to:
   handle a centralized database.
(17) The communication network node of anyone of (1) to (16), further configured to:
   use a pre-defined table for determining the environmental costs.
(18) A method carried out in a communication network node comprising:
   determining environmental costs of a user's journey based on journey data of the user and based on at least one route option for the journey.
(19) The method of (18), wherein the environmental costs are further determined based on at least one of a transport type, a distance, a journey time, an energy source, and an environmental cost coefficient.
(20) The method of (18) or (19), wherein the environmental costs are determined for different suggested journeys for the user.
(21) The method of anyone of (18) to (20), further comprising:
   determining whether a total of environmental costs of the user in a predetermined time period exceeds a predetermined threshold.
(22) The method of anyone of (18) to (21), further comprising:
   obtaining energy data from an energy provider network node.
(23) The method of anyone of (18) to (22), further comprising:

communicating with an environment cost database network node for recording energy data.
(24) The method of anyone of (18) to (23), further comprising:
   obtaining an environmental cost coefficient for determining the environmental costs.
(25) The method of (24), wherein the environmental cost coefficient is obtained based on a transport type of the journey.
(26) The method of (25), further comprising:
   determining a capacity of the transport type.
(27) The method of (26), further comprising:
   determining a number of passengers; and
   determining, based on the number of passengers, whether an increase of the capacity is indicated.
(28) The method of (27), further comprising:
   determining, based on at least one of the number of passengers, the transport type, and the capacity, whether a change of the transport type leads to a decrease of the environmental costs.
(29) The method of (28), further comprising:
   offering an alternative transport, if the environmental costs can be decreased thereby.
(30) The method of anyone of (24) to (29), wherein the environmental cost coefficient is determined based on at least one of an energy consumption, an emission conversion value, a journey distance, and a number of passengers.
(31) The method of anyone of (18) to (30), further comprising:
   offering a conditional booking based on an expected future number of passengers and based on the expected environmental costs per future number of passengers.
(32) The method of anyone of (18) to (31), further comprising:
   handling a distributed ledger with the communication network node.
(33) The method of anyone of (18) to (32), further configured to:
   handling a centralized database with the communication network node.
(34) The method of anyone of (18) to (33), further comprising:
   using a pre-defined table for determining the environmental costs.
(35) User equipment configured to communicate with a communication network node, the user equipment comprising circuitry configured to:
   obtain environmental costs of a user's journey which are determined based on journey data of the user and based on at least one route option for the journey.
(36) The user equipment of (35), further configured to:
   provide a destination to the communication network node for determining the environmental costs of the journey.
(37) The user equipment of (35) or (36), further configured to:
   provide candidate routes associated with the environmental costs for each candidate route to a user.
(38) The user equipment of (37), further configured to:
   offer a reward to the user associated with at least one candidate route.
(39) A method carried out in user equipment configured to communicate with a communication network node, the method comprising:
   obtaining environmental costs of a user's journey which are determined based on journey data of the user and based on at least one route option for the journey.
(40) The method of (39), further comprising:
   providing a destination to the communication network node for determining the environmental costs of the journey.
(41) The method of (39) or (40), further comprising:
   providing candidate routes associated with the environmental costs for each candidate route to a user.
(42) The method of (41), further comprising:
   offering a reward to the user associated with at least one candidate route.
(43) A communication system comprising communication network nodes and circuitry configured to:
   determine environmental costs of a user's journey based on journey data of the user and based on at least one route option for the journey.
(44) The communication system of (43), further configured to:
   record the journey in a blockchain.
(45) The communication system of (43) or (44), further configured to:
   determine the environmental costs in a first subset of the communication network nodes.
(46) The communication system of (45), further configured to:
   determine, in a second subset different from the first subset of the communication network nodes, whether a total of environmental costs of the user in a predetermined time period exceeds a predetermined threshold.
(47) The communication system of anyone of (43) to (46), further configured to:
   handle a distributed ledger.
(48) The communication system of anyone of (43) to (47), further configured to:
   handle a centralized database.
(49) The communication system of anyone of (43) to (48), further configured to:
   use a pre-defined table for determining the environmental costs.
(50) A method carried out in a communication system comprising communication network nodes, the method comprising:
   determining environmental costs of a user's journey based on journey data of the user and based on at least one route option for the journey.
(51) The method of (50), further comprising:
   recording the journey in a blockchain.
(52) The method of (50) or (51), further comprising:
   determining the environmental costs in a first subset of the communication network nodes.
(53) The method of (52), further comprising:
   determining, in a second subset different from the first subset of the communication network nodes, whether a total of environmental costs of the user in a predetermined time period exceeds a predetermined threshold.
(54) The method of anyone of (50) to (53), further comprising:
   handling a distributed ledger with the communication network node.
(55) The method of anyone of (50) to (54), further configured to:
   handling a centralized database with the communication network node.
(56) The method of anyone of (50) to (55), further comprising:
   using a pre-defined table for determining the environmental costs.
(57) A computer program comprising program code causing a computer to perform the method according to anyone of (18) to (34) and/or (39) to (42) and/or (50) to (56), when being carried out on a computer.
(58) A non-transitory computer-readable recording medium that stores therein a computer program product, which, when executed by a processor, causes the method according to anyone of (18) to (34) and/or (39) to (42) and/or (50) to (56) to be performed.

1. A communication network node-comprising circuitry configured to:
determine environmental costs of a user's journey based on journey data of the user and based on at least one route option for the journey.

2. The communication network node of claim 1, wherein the costs are further determined based on at least one of a transport type, a distance, a journey time, an energy source, and an environmental cost coefficient. Environmental

3. The communication network node of claim 1, wherein the environmental costs are determined for different suggested journeys for the user.

4. The communication network node of claim 1, further configured to:
determine whether a total of environmental costs of the user in a predetermined time period exceeds a predetermined threshold.

5. The communication network node of claim 1, further configured to:
obtain energy data from an energy provider network node.

6. The communication network node of claim 1, further configured to:
communicate with an environment cost database network node for recording energy data.

7. The communication network node of claim 1, further configured to:
obtain an environmental cost coefficient for determining the environmental costs.

8. The communication network node of claim 7, wherein the environmental cost coefficient is obtained based on a transport type of the journey.

9. The communication network node of claim 8, further configured to:
determine a capacity of the transport type.

10. The communication network node of claim 9, further configured to:
determine a number of passengers; and
determine, based on the number of passengers, whether an increase of the capacity is indicated.

11. The communication network node of claim 10, further configured to:
determine, based on at least one of the number of passengers, the transport type, and the capacity, whether a change of the transport type leads to a decrease of the environmental costs.

12. The communication network node of claim 11, further configured to:
offer an alternative transport, if the environmental costs can be decreased thereby.

13. The communication network node of claim 7, wherein the environmental cost coefficient is determined based on at least one of an energy consumption, an emission conversion value, a journey distance, and a number of passengers.

14.-34. (canceled)

35. User equipment configured to communicate with a communication network node, the user equipment comprising circuitry configured to:
obtain environmental costs of a user's journey which are determined based on journey data of the user and based on at least one route option for the journey.

36. The user equipment of claim 35, further configured to:
provide a destination to the communication network node for determining the environmental costs of the journey.

37. The user equipment of claim 35, further configured to:
provide candidate routes associated with the environmental costs for each candidate route to a user.

38. The user equipment of claim 35, further configured to:
offer a reward to the user associated with at least one candidate route.

39. A method carried out in user equipment configured to communicate with a communication network node, the method comprising:
obtaining environmental costs of a user's journey which are determined based on journey data of the user and based on at least one route option for the journey.

40. The method of claim 39, further comprising:
providing a destination to the communication network node for determining the environmental costs of the journey.

41. The method of claim 39, further comprising:
providing candidate routes associated with the environmental costs for each candidate route to a user.

42.-56. (canceled)
